(19) United States
(12) Patent Application Publication
(10) Pub. No.: US 2013/0333055 A1
(43) Pub. Date: Dec. 12, 2013

(54) SYSTEM AND METHOD FOR TRANSFERENCE OF RIGHTS TO DIGITAL MEDIA VIA PHYSICAL TOKENS

(71) Applicant: barnesandnoble.com llc, New York, NY (US)

(72) Inventors: Matthew PALLAKOFF, Mountain View, CA (US); Luis Daniel MOSQUERA, Foster City, CA (US); Harold Edward COHN, Incline Village, NV (US)

(21) Appl. No.: 13/910,865

(22) Filed: Jun. 5, 2013

Related U.S. Application Data
(60) Provisional application No. 61/656,845, filed on Jun. 7, 2012.

(51) Int. Cl. H04L 29/06

(52) U.S. Cl. CPC H04L 63/10
USPC 726/29

(57) ABSTRACT

A system and method for transferring digital content includes a physical token incorporating a Near Field Communication (“NFC”) tag that represents a virtual gift of digital content such as an eBook. The tag can include a Uniform Resource Locator (URL) that can be used to gain access to the electronic content which can be stored on a remote server. A unique identifier on the tag is associated with gifted digital content. This association is preferably stored on a remote server in the “cloud”. A user receiving the physical and places it on or next to their electronic device, which includes an NFC receiver, and the device reads the tag and connects to the remote server. The remote server validates the information on the token and provides the user with access to the digital content, such as downloading the digital content to the user's electronic device.

### FIELD OF THE INVENTION

The present invention generally relates to the transference of rights to digital media, and more particularly to systems and method for transferring rights using a physical token and Near Field Communication technology.

### BACKGROUND OF THE INVENTION

Gift cards are an ever increasingly popular method of providing gifts. A gift card is typically a restricted monetary equivalent that is issued by retailers to be used as an alternative to a non-monetary gift. Highly popular, they rank as the second-most given gift by consumers in the United States, the most-wanted gift by women, and the third-most wanted by males. Gift cards have become increasingly popular as they relieve the donor of searching for and selecting a specific gift. The recipient of the gift card can use it at his or her discretion within the restrictions set by the issuing agency.

A gift card typically resembles a credit card with a display of a specific theme on the card. The card is identified by a specific number or code rather than being associated with a specific individual. The card are supported by an on-line electronic system for authorization.

Cards may have a barcode or magnetic strip, which is read by an electronic credit card machine. Many cards have no value until they are sold, at which time the cashier at the retail location enters the amount which the customer wishes to put on the card. This amount is rarely stored on the card but is instead noted in the retail store's database, which is crosslinked to the card ID. To thwart counterfeiting, the data on the card is typically encrypted.

Gift cards differ from gift certificates, in that the latter are usually sold as a paper document with an authorized signature by a restaurant, store, or other individual establishment as a voucher for a future service; there is no electronic authorization.

It has been argued that holiday giving destroys value due to mismatching gifts. The most efficient way to keep value in gifting would be to give cash, however this is socially acceptable only within limits. Gift cards, to a degree, may overcome this problem but have certain pitfalls. Some feel that the absence of the thought of selecting a specific gift makes a gift card a worse choice than a poorly executed but individual gift. New products in the gift card industry are evolving to tackle this “impersonal” pitfall of gift cards.

### SUMMARY OF THE INVENTION

The physical token of the present invention incorporates a Near Field Communication (“NFC”) tag that represents a virtual gift such as eBook, video, application, or other electronic content. The tag can include a Uniform Resource Locator (URL) that can be used to gain access to the electronic content which can be stored on a remote server. The tag is housed within a physical token such as traditional gift card or poker chip, each having unique branding. In the preferred embodiment, the unique identifier on the tag is associated with gifted digital content, e.g., an eBook. This association is preferably stored on a remote server in the “cloud” for later validation when the token is used.

When a user receives the physical token and places it on or next to their electronic device, e.g., an eBook reader, which includes an NFC receiver, the device reads the tag and connects to the source for the gifted digital content. The source for the digital content, typically the remote server, validates the information on the token and downloads the digital content to the user's electronic device. Optionally, the device automatically opens the content. Using an animation, the digital content can appear to materialize on the user's device when the token is brought into physical proximity to the device.

The present invention provides an ease of use for distributing electronic content unknown in the prior art. Very little effort is required by the user (giftee) to trigger the action of downloading and displaying or playing the content. In one traditional method of distribution, one would be required to scratch to reveal a secret code from a gift card, and then enter that lengthy code into their device or website to achieve a similar effect. In the present invention, the gift is immediately transferred and/or opened on the device.

The gifted content does not have to be stored on the user's device entirely and could represent a key that enables real-time streaming of content to their device instead, or triggers some other digital experience on the device.

Furthermore, the content does not have to be a gift. It could be a collection of content recommendations or links to sample content that is loaded or streamed.

The physical token can be programmed easily by the user and then distributed to friends, family, coworkers, students, etc. For example, a teacher might create and distribute a reading list to their class by programming tokens and handing them out to students. Students then place these tokens on their device that causes the entire reading list to appear on their device and/or in their account.

Tokens can be applied to marketing and promotional use where a company distributes free tokens to customers in retail stores (or sent via mail). The tokens of the present invention significantly enhance convenience to customers over traditional transference of gift card information.

Additional embodiments and permutations around this basic concept are enabled. A token might represent, among other things: different types of media, e.g., eBooks, magazines, newspapers, videos, applications or music; a single instance of media; multiple instances of media, e.g., a group or “bundle” of digital content and/or experiences; a magazine or newspaper subscription; virtual currency or rewards that can be credited to a user's account; a website URL; promotions, discounts or coupons; a full rendition of content, samples of content, or a loan of content.

A token may have one use, multiple uses, or a period before expiration. The token can trigger a personalized message that appears to the user prior to opening the gifted content. The token can trigger automatic download and opening of content on a device. The token can trigger automatic streaming of content, perhaps with user confirmation. The token can trigger automatic borrowing of content, perhaps with user confirmation.

A token can represent digital content or experiences that have already been paid for (as would be the case with gifts), or content that doesn't require purchasing, or content that the user can sample and then choose to purchase.

A token gives consumers the flexibility to purchase and gift one or more digital items. A token can represent a collection of two or more items of same or varying content types. For example, it might represent the complete works of Shakespeare, or a subscription to one or more magazines.

As a container for book samples, tokens according to the present invention can be printed en mass and handed out freely anywhere, at stores, at malls, in the mail, etc. Users can be encouraged to virally spread them to their friends.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a token that incorporates an NFC tag;

FIG. 2 is a flow chart illustrating an exemplary method according to the present invention;

FIG. 3 is a system according to the present invention;

FIGS. 4A and 4B are illustrations of a use of a token; and

FIG. 5 illustrates the components of an exemplary device.

### DETAILED DESCRIPTION OF THE INVENTION

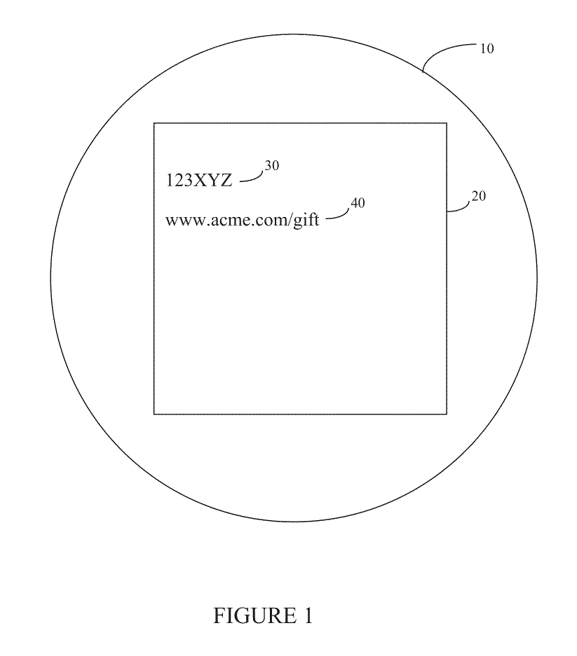

Referring to FIG. 1, and in the description that follows, the term “magic token” refers to the physical token 10 of the present invention. The magic token 10 has an NFC tag 20 that is embedded into a physical housing, for example a poker chip like housing. Although a poker chip like housing is illustrated in FIG. 1, as appreciated by those skilled in the art, the actual form and shape of the housing of token 10 can be varied, such as in the shape of a traditional gift or credit card. Unorthodox shapes of the token housing can also be used for particular promotions or purposes, as the housing does not perform any particular functionality other than as a carrier for the NFC tag 20.

In the preferred embodiment, the NFC tag 20 includes a unique identifier 30 that uniquely identifies the token 10. The NFC tag 20 can also further include a URL 40 that links to a website as further described below.

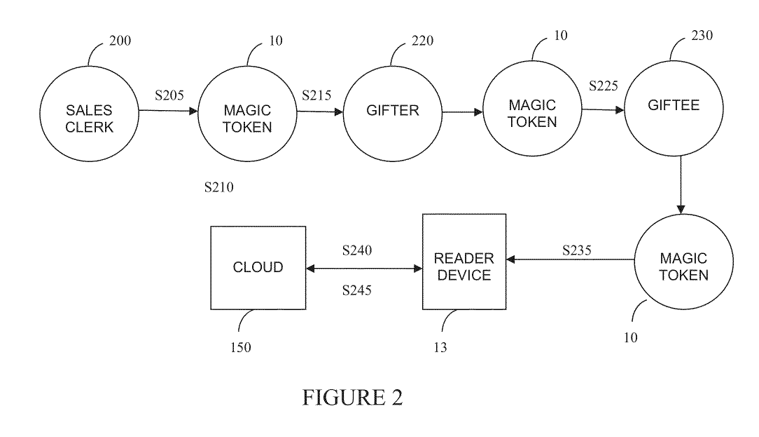

The preferred embodiment of the present invention is the case where a gifter (gift giver) purchases one or more eBooks at a retail location (or via the web) and receives a magic token 10 to give to a giftee (gift receiver). The process of this embodiment is illustrated in FIG. 2.

In a retail store, a sales clerk 200 rings up a sale of one or more eBooks for a customer, gifter 220. Although the example of eBooks is used throughout this discussion, it is appreciated that other forms of digital content, e.g., digital magazines, videos, music, can be gifted in accordance with the present invention. The sales associate 200 takes a “blank” token 10, and scans it, step S205, with an NFC scanner (a mobile or other device) to read the unique identifier programmed on the NFC tag 20 embedded in the token 10. In the preferred embodiment, the unique identifier is preprogrammed onto the token 10, but the unique identifier can be programmed onto the token 10 at the Point of Sale (POS) location. The term “blank” is used herein to refer to tokens 10 that have not been associated with digital content.

The sales associate 200 associates that tag 20 with one or more of the eBooks purchased by the gifter 220. Alternatively, the system at the POS location can automatically associate the tag 20 with the gifts just input by the sales associate 200. The association may be one or multiple eBooks or other content per token 10. Mixed forms of content such as eBooks and videos are permissibly associated with a single token 10. The association between the tag 20 and the purchased eBook(s) is then stored, step S210, on the cloud 150. As known in the art, the cloud 150 is one or more remote servers for storing data, applications or content.

The associate 200 provides the token 10, step S215, to the gifter 220 who later gives the token, step S225, to the giftee 230. In other embodiments, the tokens may be pre-associated with specific content at the NFC tag-printing house or at a distribution center. Further, the purchase of the digital content can be done online and the token 10 can either be shipped to the gifter 220 or giftee 230 or she can visit a retail location to pick up the token 10. In an alternative embodiment, the sales associate 200 can actually program the NFC tag 20 on token 10 with additional information such as a URL 40, promotional material, or a time-stamp or other security mechanism that can be used to thwart potential pirates.

Once a giftee 230 receives a token 10, she places, step S235, the token 10 on or near her electronic device 130 that has an NFC reader. In a preferred embodiment, the electronic device is a dedicated Ebook reader or a tablet device that is capable of displaying or playing the gifted content. The device 130 reads the unique identifier off of the NFC tag 20. In a preferred embodiment, as further described below, the device 130 is a device registered to use the system of the present invention and has specific application software thereon. This system specific application software recognizes the NFC tag as a tag distributed by the system. In this preferred embodiment, a Home application is brought up on the device 130, and an icon representing the gifted content appears in New & Recent shelf (or other spot on Home reserved for displaying new items). The device 130 sends, step S240, a request for access to the digital content to the cloud 150. The request includes the token's unique identifier that is used for validation. In this preferred embodiment, the request also includes an identification of the device 130 that had been previously registered with the cloud. The cloud performs a validation process in which the token's unique identifier contained in the request is validated against the association of the unique identifier and the digital content previously stored in the cloud when the token 10 was purchased as described above.

If the validation process is successful, the cloud 150 responds, step S245, by sending the device 130 a confirmation and a personalized message that the gifted content is being added to the user's locker (as described below) and/or downloaded. A personalized message from the gifter 220 might appear in a dialog box on the screen of the device 130. That dialog might ask the user if they wish to open one of the files once it has finished downloading. This triggering event might also send a confirmation email back to the gifter 220 to let her know that the giftee 230 received his gift. At this point the transaction is complete.

In the preferred embodiment, the device 130 is a Nook™ by Barnes & Noble. The token can be placed on a non-nook Android™ device as well. If the user has an Android™ phone or tablet with Gingerbread™ release or above, placing the token 10 on the device 130 will automatically launch the Nook™ application because the Nook™ application registers the token scheme with Android™. When the device 130 scans a magic token 10, it launch the Nook™ application.

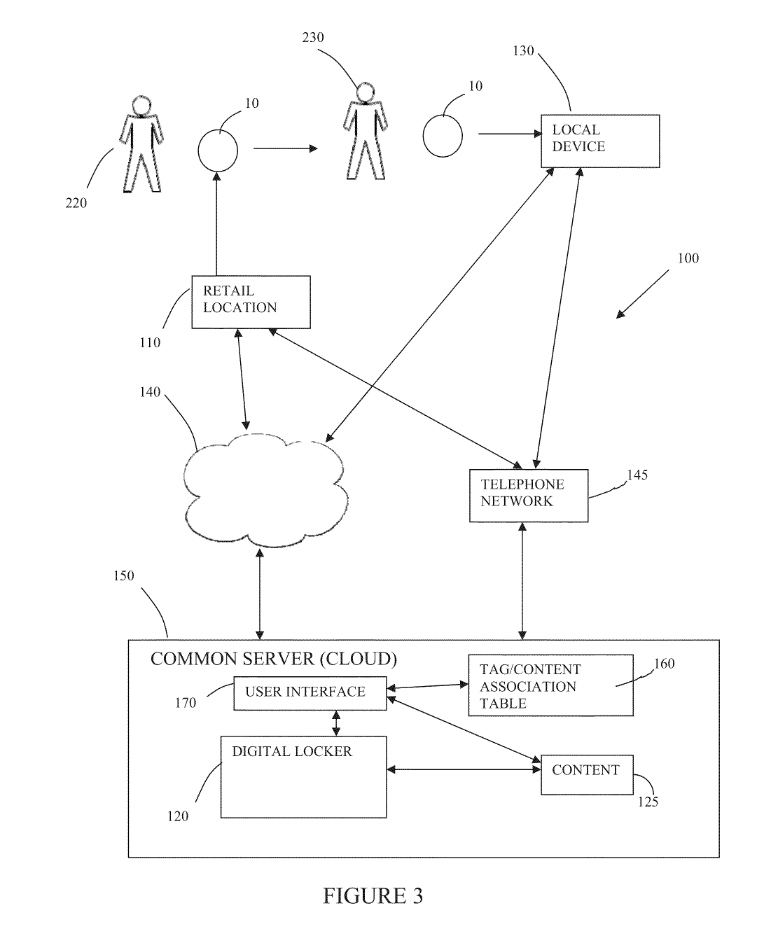

If the giftee's device 130 does not have the Nook™ application installed, the operating system opens a browser and takes the user to the URL 40 specific in the NFC tag 20, in this case a link to the content provider's website. Once the user's device connects to the website, the website validates the NFC tag 20 read from the token 10 and provides the giftee 230 with access to the content that was previously associated with the tag 20 as described above. On the website, the personalized giftee message can be displayed. As further described below, if the user does not have a locker (account) on the server 150 (see FIG. 3), this is an opportunity to open one for them to receive the content. The user could be prompted to download the Nook™ application to their device 130, or they could read the content on the Web.

Due to present limitations, NFC tags 20 only have sufficient space to store a unique identifier 30 and short web address 40. They cannot store the full content of an eBook or video. What is stored on the tag 20 is simply a unique identifier 30 and a web address 40. The identifier 30 is unique to each tag. This allows easy association of any given tag 20 with specific content, actions, messages, transactions, currency, etc., on the cloud 150.

FIG. 3 illustrates an exemplary system 100 according to the present invention. Gifter 220 can visit a retail location 110 in order to purchase digital content 125 that is then associated with a token 10 (via the NFC tag 20). As described above, the association of the token 10 to the purchased content 125 is sent from the retail location 110 to the cloud 150. In the cloud 150, this association is stored in a tag/content association table 160. The cloud 150 is a key component of the system that both contains and validates token associations with content, using table 160. In the preferred embodiment, server 150 also stores the content 125 and can present the content 125 via the Web (using User Interface 170) or download or stream the content 125 to a user's device 130. As appreciated by those skilled in the art, many of the functions described herein can be divided between the server 150 and the user's local device 130. Further, as also appreciated by those skilled in the art, server 150 can be considered a “cloud” with respect to the user and her local device 130. The cloud can actually be comprised of several servers performing interconnected and distributed functions. For the sake of simplicity in the present discussion, only a single server 150 will be described.

After the token 10 has been associated with the content 125, the gifter 220 gives the physical token 10 to the giftee 230. As described above, the giftee 230 places the token 10 on or near her device 130 which reads the unique identifier 30 on the NFC tag 20. With this unique identifier 30 in hand, the giftee's device 130 sends a request to the cloud 150 to obtain access to the digital content. The tag identifier 30 is contained in the request from the device 130 to the could 150. The cloud 150 validates the request by verifying the association of the unique tag identifier 30 and the purchased content 125 contained in the tag/content association table 160. The giftee's device 130 can connect to the server 150 via the Internet 140, a telephone network 145 (e.g., wirelessly through a cellphone network) or other suitable electronic communication means.

In a preferred embodiment, giftee 230 has an account on lending server 150, which authorizes giftee 230 to use system 100. In this preferred embodiment, the giftee's device 130 is registered with the giftee's account and the request from device 130 also includes an identification of the giftee's device 130. Associated with the giftee's account is giftee's digital locker 120 located on the server 150. As further described below, in the preferred embodiment of the present invention, digital locker 120 contains links to copies of digital content 125 previously purchased (or otherwise legally acquired) by giftee 230.

Once the server 150 has validated the association of the token 10 and the purchased content 125 using the tag/content association table 160, and has verified that the user's device 130 is a registered device, the server 150 can make the content 125 accessible to the giftee 230 through her digital locker 120.

Indicia of rights to all copies of digital content 125 owned by giftee 230, including digital content 125 gifted via the token 10, is stored by reference in digital locker 120. Digital locker 120 is a remote online repository that is uniquely associated with the giftee's account. As appreciated by those skilled in the art, the actual copies of the digital content 125 are not necessarily stored in the giftee locker 120, but rather the locker 120 stores an indication of the rights of the user to the particular content 125 and a link or other reference to the actual digital content 125. Typically, the actual copy of the digital content 125 is stored in another mass storage (not shown). The digital lockers 120 of all of the users who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the server 150 can contain millions of files 125 containing digital content. It is also contemplated that the server 150 can actually be comprised of several servers with access to a plurality of storage devices containing digital content 125. As further appreciated by those skilled in the art, in conventional licensing programs, the user does not own the actual copy of the digital content 125, but has a license to use it. Hereinafter, if reference is made to “owning” the digital content 125, it is understood what is meant is the license or right to use the content 125.

Local device 130 is an electronic device such as a personal computer, an e-book reader, a smart phone or other electronic device that the giftee 230 can use to access the server 150. In a preferred embodiment, the local device 130 has been previously associated, registered, with the giftee's account using giftee's account credentials. Local device 130 provides the capability for giftee 230 to download giftee's copy of digital content 125 via his or her digital locker 120. After digital content 125 is downloaded to local device 130, giftee 230 can engage with the downloaded content locally, e.g., read the book, listen to the music or watch the video.

In a preferred embodiment, local device 130 includes a non-browser based device interface that allows giftee 230 to initiate the functionality of system 100 in a non-browser environment. Through the device interface, giftee 230 is automatically connected to the server 150 in a non-browser based environment. This connection to the server 150 is a secure interface and can be through the telephone network 145, typically a cellular network for mobile devices. If giftee 230 is accessing his or her digital locker 120 using the Internet 140, local device 130 also includes a web account interface. Web account interface provides giftee 230 with browser-based access to his or her account and digital locker 120 over the Internet 140.

As described above, giftee 230 does not have to be an authorized user of system 100 with an account and a digital locker 120. In the preferred embodiment, if the giftee 230 is not an authorized user of system 100, the operating system on device 130 opens a browser and takes the giftee 230 to the URL 40 specific in the NFC tag 20 on the token 10, in this case a link to the content provider's website on server 150. Here, a personalized giftee message can be displayed. The server 150 can then invite the giftee 230 to become an authorized user, open an account and establish a locker 120. If the giftee 230 accepts, the locker 120 is created and the content 125 is “put” into the newly established giftee locker 120. The giftee 230 can then download the content 125 to her device 130. If the giftee does not wish to establish account, she can access (read) the content 125 on the Web, and depending on the specific content 125, does not have the option to download the content to her device 130.

Further, as described above, in the preferred embodiment, the user 230 is an authorized user and her device 130 is registered with the cloud 150. However the giftee 230 may use the token 10 with a device 130 that is not registered with the cloud 150. In this case, when the device 130 uses the URL on the token 10 to connect to the server 150. The server 150 can offer the user 230 to sign in and authenticate herself. e.g., via username and password. In a preferred embodiment, after the user has authenticated herself, she will be offered the opportunity to register her device 130. If the user declines to register the device, in the preferred embodiment, the server 150 will not allow the user to download the digital content to the unregistered device 130, but will allow her to access the digital content online.

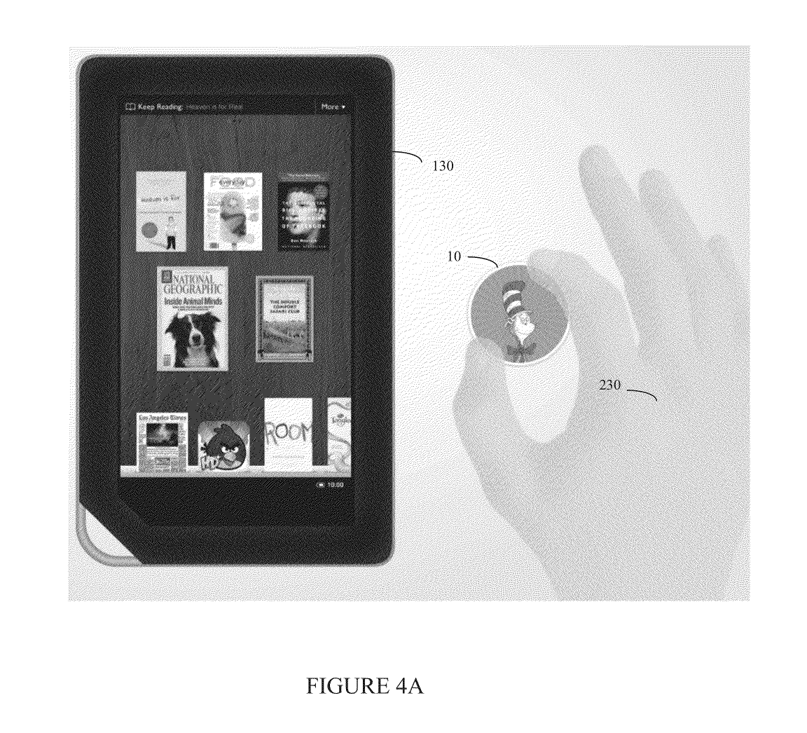

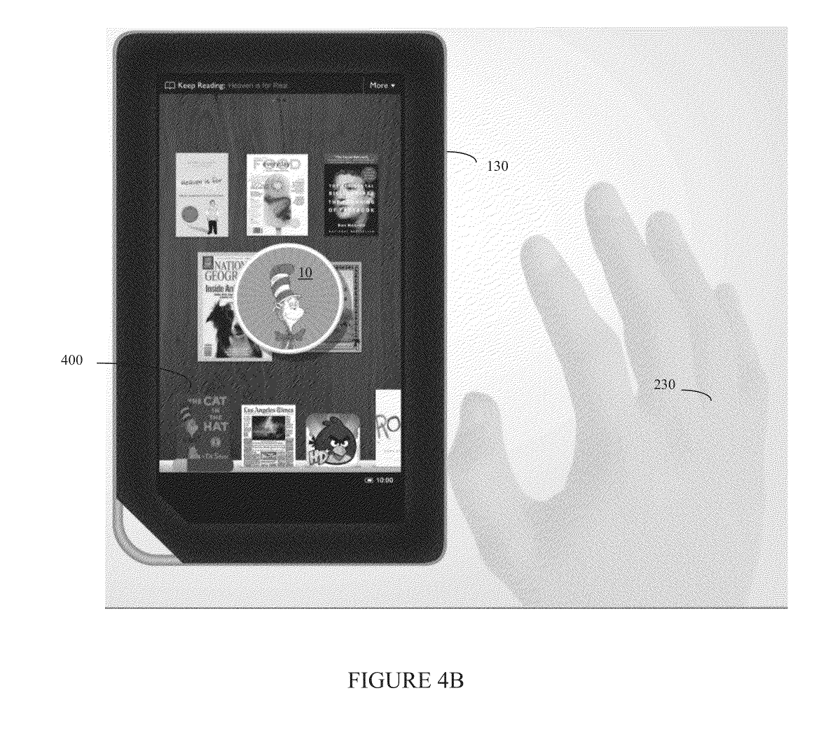

FIGS. 4A and 4B illustrate a practical use of a use of a token 10. After a giftee 230 has received a token 10, she places the token 10 on or near her device 130 that has an NFC reader. The device 130 reads the unique identifier off of the NFC tag 20. In a preferred embodiment, a Home application as illustrated in FIGS. 4A and 4B is brought up on the device 130. As shown in FIG. 4B, and an icon 400 representing the gifted content appears in a New & Recent shelf or other element of the user interface where a user expects to see newly acquired content on the Home screen. In the embodiment shown in FIG. 4B, the icon 400 is in the form of a thumbnail image of the content 125 being gifted. In the preferred embodiment as illustrated in FIGS. 4A and 4B, tapping the token 10 on or very near the device 130 results in a book cover (or related graphical representation of digital content) being animated to appear to “materialize” in final position in a section of the user interface where the user looks for recently acquired content. In an alternative embodiment, The user drops the token 10 on an area reserved for her “favorite” content, and the book cover thumbnail materializes right there—under (or close to) the spot where the user drops the token 10.

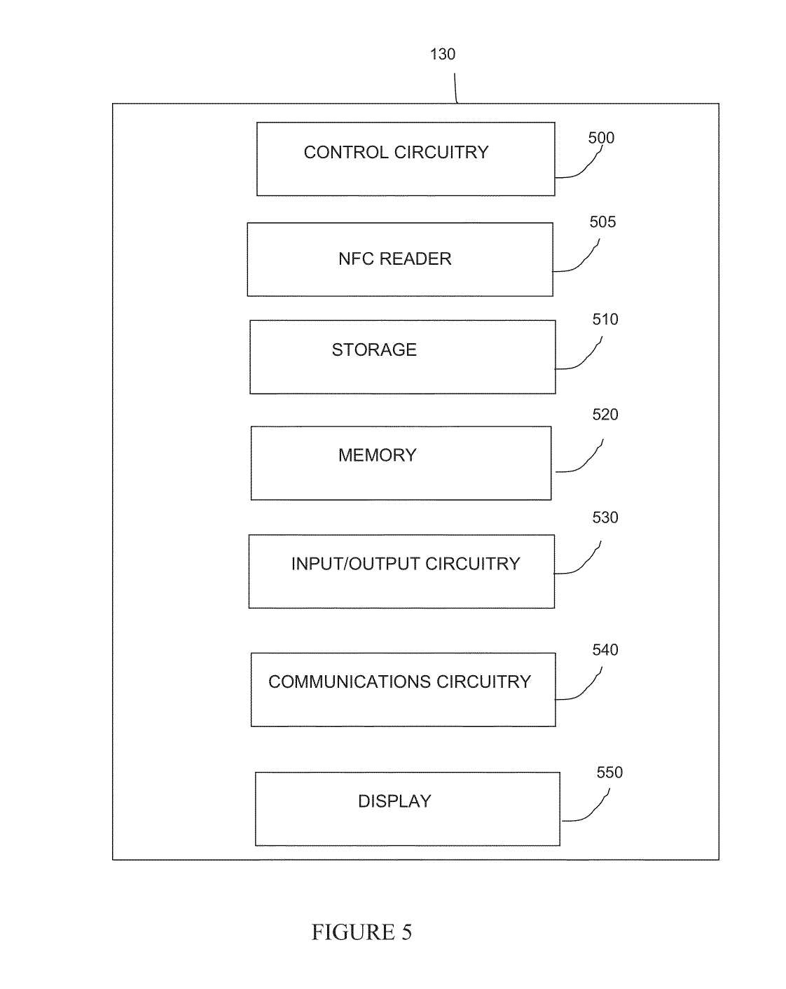

FIG. 5 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in this Figure, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

NFC Reader component 505 includes the hardware necessary to read NFC tags and the software operable to communicate the sensed information from an NFC tag to the control circuitry 500. The NFC Reader component 505 is coupled to control circuitry 500 that controls the various input and output to and from the other various components. NFC is a set of short-range wireless technologies, typically requiring a distance of 4 cm or less. NFC operates at 13.56 Mhz on ISO/IEC 18000-3 air interface and at rates ranging from 106 kbit/s to 424 kbit/s. NFC always involves an initiator and a target. In the present case, the NFC Reader component 505 acts as the initiator to actively generates a radio frequency (RF) field that can power the NFC tag 20 in the token 10 (the passive target). Typically, NFC uses magnetic induction between two loop antennas located within each other's near field, effectively forming an air-core transformer. NFC operates within the globally available and unlicensed radio frequency ISM band of 13.56 MHz. Most of the RF energy is concentrated in the allowed ±7 kHz bandwidth range, but the full spectral envelope may be as wide as 1.8. The theoretical working distance using compact standard antennas is up to 20 cm with a practical working distance of about 4 cm.

In the passive communication mode in the preferred embodiment of the present invention, the NFC Reader component 505 provides a carrier field and the NFC tag 20 answers by modulating the existing field. In this mode, the NFC tag 20 draw its operating power from the NFC Reader component 505 provided electromagnetic field, thus making the NFC tag 20 a transponder.

Storage 510 can include, for example, one or more tangible computer storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 130 to establish a wireless connection), subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in this Figure as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronics device 130. In some embodiments, the display circuitry can include a coder/decoder (Codec) to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in this Figure to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

The present invention solves the problem of physically distributing media to users in a convenient manner. Since the tokens 10 of the present invention represents a link to content 125, not content 125 itself, the token 10 can be extremely inexpensive and easily distributed. The content 125 resides on the cloud 150 and is either downloaded to user devices 130 or streamed to them. In some cases, the content 150 is simply added to a customer's online account if not downloaded or streamed automatically.

Without the tokens 10 of the present invention, a user would be required to enter a lengthy code into their device 130 or account on the content provider's website. It would require the user launch an application and find the appropriate UI command to enter the token 10. On the web, the user would be required to login to their account, find the location to enter the code and enter the code.

There is also a psychological benefit to purchasing and giving something physical and solid (like a “gold” token) versus simply getting a code on a receipt.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for transferring rights to digital content comprising:
providing a physical token, the physical token containing a near field communication tag;
reading a unique identifier from the near field communication tag, the unique identifier uniquely identifying the physical token;
determining the digital content to be transferred;
associating, in a database on a server, the unique identifier and the digital content to be transferred;
receiving a request for access to the digital content, the request containing the unique identifier;
validating the request using the association in the database on the server; and
providing access to the digital content if the request is validated.

2. The method of claim 1, wherein the unique identifier in the received request is received from an electronic device that had read the unique identifier from the physical token.

3. The method of claim 1, further comprising:
encoding a Uniform Resource Locator (URL) on the near field communication tag, the URL providing link to the server, wherein the request is made using the URL.

4. The method of claim 3, further comprising:
providing web pages to an electronic device that made the request;
offering the user of the electronic device opportunity to register the electronic device;
if an acceptance of the offer is received:
registering the device on the server,
opening an account associated with the device, the account residing on the server,
associating the digital content with the account, and
downloading the digital content to the registered electronic device; and
if a declination of the offer is received:
providing online access to the digital content on the server.

5. The method of claim 1, wherein the request contains an identification of an electronic device that made the request, the method further comprising:
determining if the electronic device is registered with the server, and
if the electronic device is registered with the server, associating the digital content with an account on the server related to the electronic device.

6. The method of claim 5, further comprising:
downloading the digital content to the electronic device.

7. The method of claim 6, wherein the downloading of the digital content to the electronic device is automatic.

8. The method of claim 7, further comprising:
displaying a graphical representation of the digital content on a user interface screen of the electronic device.

9. The method of claim 8, wherein the act of displaying the graphical representation of the digital content further comprises:
displaying the graphical representation at a position where new content is displayed on the user interface screen.

10. The method of claim 8, wherein the act of displaying the graphical representation of the digital content further comprises:
displaying the graphical representation at a position where a user's favorite content is displayed on the user interface screen.

11. The method of claim 1, wherein the act of providing access to the digital content further comprises:
streaming the digital content in real time to an electronic device.

12. The method of claim 1, wherein the digital content is an electronic book, electronic magazine, electronic newspaper, video, software applications or digital music.

13. A system for transferring rights to digital content comprising:
a memory that includes instructions for operating the system, and includes a digital content database containing digital content;
control circuitry coupled to the memory the control circuitry capable of executing the instructions and is operable to at least:
receive a request to associate a unique identifier contained in near field communication tag on a physical token with specified digital content to be transferred, the unique identifier uniquely identifying the physical token;
associate, in a tag content database in the memory, the unique identifier and the specified digital content to be transferred;
receive a request for access to the specified digital content, the request containing the unique identifier;
validate the request using the association in the in a tag content database; and
provide access to the specified digital content if the request is validated.

14. The system of claim 13, wherein the unique identifier in the received request is received from an electronic device that had read the unique identifier from the physical token.

15. The system of claim 13, wherein the request is received through a connection established by a Uniform Resource Locator

16. The system of claim 13, wherein the control circuitry is further operable to execute the instructions to:
provide web pages to an electronic device that made the request;
offer the user of the electronic device opportunity to register the electronic device;
if an acceptance of the offer is received:
register the device on the server,
open an account associated with the device, the account residing on the server,
associate the specified digital content with the account, and
download the digital content to the registered electronic device; and
if a declination of the offer is received:
provide online access to the specified digital content on the system.

17. The system of claim 13, wherein the request contains an identification of an electronic device that made the request, wherein the control circuitry is further operable to execute the instructions to:
determine if the electronic device is registered with the system; and
if the electronic device is registered with the system, associating the specified digital content with an account on the system related to the electronic device.

18. The system of claim 13, wherein the control circuitry is further operable to execute the instructions to:
download the digital content to the electronic device.

19. The system of claim 18, further comprising:
a display screen, the display screen coupled to the control circuitry,
wherein the control circuitry is further operable to execute the instructions to display a graphical representation of the digital content on the display screen.

20. The system of claim 19, wherein the control circuitry is further operable to execute the instructions to display the graphical representation at a position where new content is displayed on the user interface screen.

21. The system of claim 19, wherein the control circuitry is further operable to execute the instructions to display the graphical representation at a position where a user's favorite content is displayed on the user interface screen.

22. A system for transferring rights to digital content comprising:
a physical token;
a near field communication tag contained in the physical token, the near field communication tag containing a unique identifier that uniquely identifies the physical token;
an electronic device, the electronic device comprising:
a memory that includes instructions for operating the electronic device,
a near field communication reader,
control circuitry coupled to the memory and coupled to the near field communication reader, the control circuitry capable of executing the instructions and is operable to at least:
instruct the near field communication reader to read the unique identifier from the near field communication tag on the physical token,
generate a request for access to digital content, the request containing the unique identifier,
transmit the request to a server for validation, and
receive access to the digital content from the server.

23. The system of claim 22, wherein the near field communication tag contained in the physical token further includes a Uniform Resource Locator, the control circuitry in the electronic device is further operable to execute the instructions to:
instruct the near field communication reader to read the Uniform Resource Locator from the near field communication tag on the physical token, and
transmit the request to a server for validation using the Uniform Resource Locator.

24. The system of claim 22, wherein the electronic device is registered with the server, the control circuitry in the electronic device is further operable to execute the instructions to download the digital content to the electronic device.

25. The system of claim 22, wherein the electronic device is not registered with the server, the control circuitry in the electronic device is further operable to execute the instructions to:
receive web pages from the server;
receive and offer from the server to register the electronic device;
transmit a response to the offer to the server;
if the response includes an acceptance of the offer:
register the device on the server,
open an account associated with the electronic device, the account residing on the server, and
download the digital content to the registered electronic device; and
if the response includes declination of the offer:
obtain online access to the digital content on the server.

26. The system of claim 22, wherein the digital content is an electronic book, electronic magazine, electronic newspaper, video, software applications or digital music.
